(19) United States
(12) Patent Application Publication
(10) Pub. No.: US 2024/0144058 A1
(43) Pub. Date: May 2, 2024

(54) PROBABILISTIC INFERENCE FROM IMPRECISE KNOWLEDGE

(71) Applicant: INTERNATIONAL BUSINESS MACHINES CORPORATION, ARMONK, NY (US)

(72) Inventors: Radu Marinescu, Dublin (IE); HAIFENG QIAN, Mount Kisco, NY (US); Debarun Bhattacharjya, New York, NY (US); Alexander Gray, Yonkers, NY (US); Francisco Barahona, White Plains, NY (US); Tian GAO, Berkeley Heights, NJ (US); Ryan Nelson Riegel, Carrollton, GA (US)

(21) Appl. No.: 18/050,621

(22) Filed: Oct. 28, 2022

(51) Int. Cl. G06N 5/04; G06N 5/02

(52) U.S. Cl. CPC G06N 5/048; G06N 5/02

(57) ABSTRACT

According to one embodiment, a method, computer system, and computer program product for probabilistic inference from imprecise knowledge is provided. The embodiment may include identifying a knowledge base of one or more statements and first probability distributions corresponding to each of the one or more statements. The embodiment may also include identifying one or more queries. The embodiment may further include determining logical inferences about and second probability distributions for queries from the one or more queries or statements from the one or more statements based on information in the knowledge base.

### BACKGROUND

The present invention relates generally to the field of computing, and more particularly to computational logic.

Computational logic is a series of techniques by which computers can solve complex problems with complex logical features quickly and accurately. Game theoretical, probabilistic, and statistical problems all scale to demand complex solutions. Computational logic can help computers expand a knowledge base and solve problems, either directly or in combination with statistical methods, simulation, artificial intelligence, and machine learning. Sophisticated logical models can be used to improve risk analytics, game strategy, and scientific research.

### SUMMARY

According to one embodiment, a method, computer system, and computer program product for probabilistic inference from imprecise knowledge is provided. The embodiment may include identifying a knowledge base of one or more statements and first probability distributions corresponding to each of the one or more statements. The embodiment may also include identifying one or more queries. The embodiment may further include determining logical inferences about and second probability distributions for queries from the one or more queries or statements from the one or more statements based on information in the knowledge base.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a process to make probabilistic inferences using imprecise knowledge according to at least one embodiment.

FIG. 3 depicts a knowledge graph depicting connections between statements according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to computational logic. The following described exemplary embodiments provide a system, method, and program product to, among other things, make probabilistic inferences using imprecise knowledge. Therefore, the present embodiment has the capacity to improve the technical field of computational logic by using a knowledge base composed of probabilistic logical statements, queries, and evidence to draw useful probabilistic inferences.

As previously described, computational logic is a series of techniques by which computers can solve complex problems with complex logical features quickly and accurately. Game theoretical, probabilistic, and statistical problems all scale to demand complex solutions. Computational logic can help computers expand a knowledge base and solve problems, either directly or in combination with statistical methods, simulation, artificial intelligence, and machine learning. Sophisticated logical models can be used to improve risk analytics, game strategy, and scientific research.

Computational logic is often useful in reasoning about probability, particularly in the contexts of risk analytics and game strategy. However, current logical solutions assume simple, precise probabilities or weights, which do not accurately reflect uncertainty or imprecision in a data set. As such, it may be advantageous to, among other things, utilize a logical credal network to reason with and make inferences about logical propositions given a probability distribution represented, for example, by a lower and upper bound.

According to one embodiment, a method for making probabilistic inferences using imprecise knowledge is provided. A logical credal network may be composed of a knowledge base, in turn composed of probabilistic statements given a distribution of probabilities within a system of logic. The logical credal network may then be used to make probabilistic inferences regarding a set of queries.

In one or more additional embodiments, composing the knowledge base may include the input of users or experts, processing information in a natural language format, or another process of artificial intelligence and machine learning. Inferences about the knowledge base may be used to rate a confidence level in the experts, perform risk analytics, or play games. For example, probabilistic inferences may be used to play “Bulls and Cows”-type games, such as Mastermind® (Mastermind and all Mastermind-based trademarks and logos are trademarks or registered trademarks of Goliath IP Stichting and/or its affiliates) or Wordle™ (Wordle and all Wordle-based trademarks and logos are trademarks or registered trademarks of The New York Times Company and/or its affiliates).

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

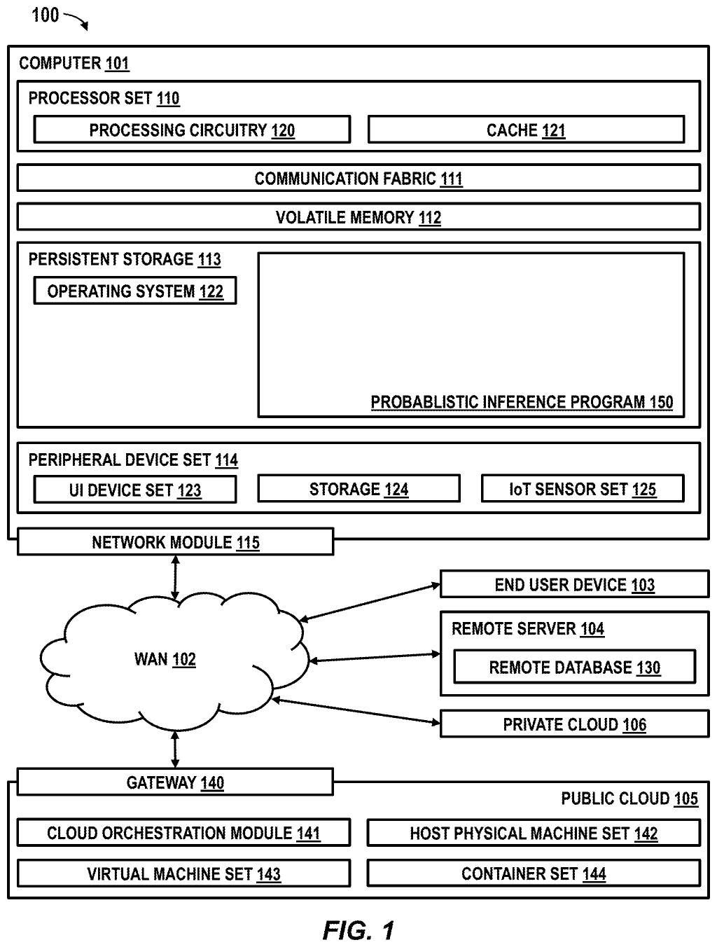

Referring now to FIG. 1, computing environment 100 contains an example of an environment for the execution of at least some of the computer code involved in performing the inventive methods, such as probabilistic inference program 150. In addition to probabilistic inference program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and probabilistic inference program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in probabilistic inference program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in probabilistic inference program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The probabilistic inference program 150 may identify a knowledge base of probability statements and a set of queries. Probability statements may be logical formulae that represent a probability distribution about the truth of a statement. Queries may be a request for such a probability distribution, and may be paired with given premises. The probabilistic inference program 150 may then make inferences in response to the queries given the information in the knowledge base.

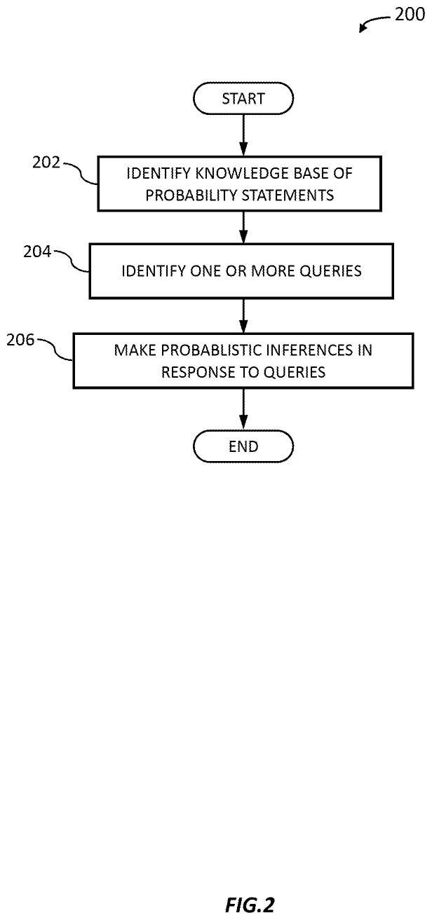

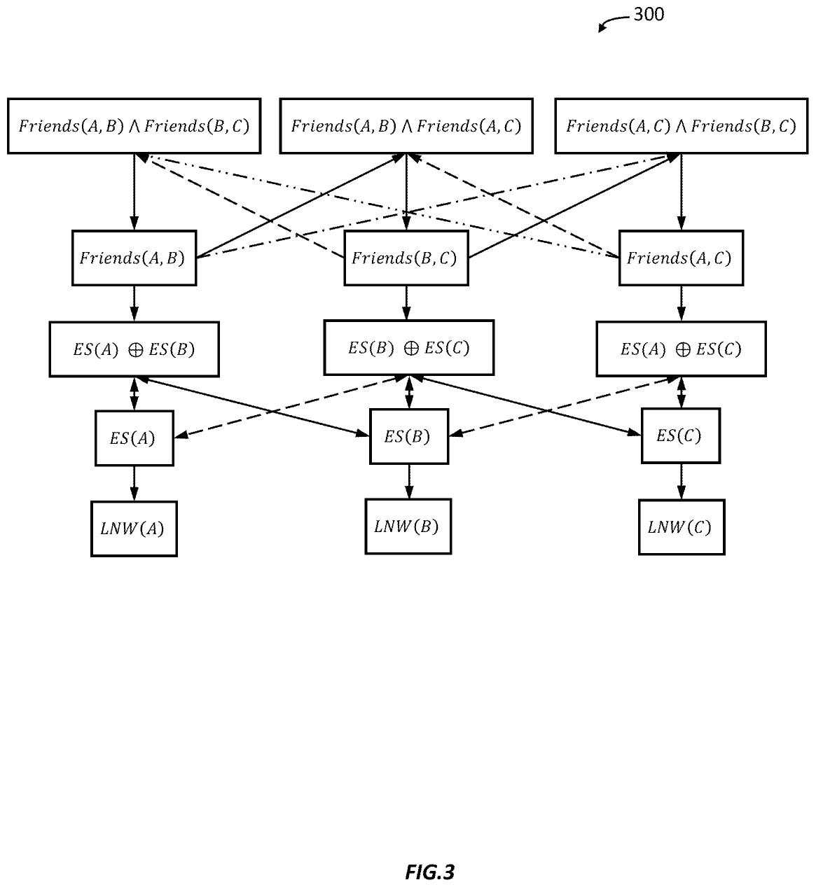

Furthermore, notwithstanding depiction in computer 101, probabilistic inference program 150 may be stored in and/or executed by, individually or in any combination, end user device 103, remote server 104, public cloud 105, and private cloud 106. The probabilistic inference method is explained in more detail below with respect to FIGS. 2 and 3.

Referring now to FIG. 2, an operational flowchart for a process of probabilistic inference from imprecise knowledge 200 is depicted according to at least one embodiment. At 202, the probabilistic inference program 150 identifies a knowledge base of statements with probability distributions in a system of logic. A probability distribution may, for example, be represented as an upper bound and lower bound of the probability that the statement is true. Such statements may be identified, for example, manually by experts, from information in other formats such as natural language, using another process of artificial intelligence, using other algorithmic methods including probabilistic inference at 206, or using a combination of techniques.

A system of logic may be, for example, propositional logic, predicate logic, or second order logic. Propositional logic may include a system of atomic propositions, such as “it is raining.” Predicate logic may include a system of atomic propositions, predicates, variables, constants, connectors, and quantifiers. For example, in the statement “There exists an X such that, if X is tall, Bob is tall,” “there exists” may be a quantifier, “X” may be a variable, “Bob” may be a constant, “if” and “then” may be a connector, and “tall” may be a predicate. Second-order logic may further include the use of quantifiers that refer to predicates. For example, second-order logic may include statements of the form “there exists a property P such that, for all X, X has property P if and only if X is an apple or X is an orange.” A variable may exist only in the context of a given statement or formula, whereas a constant may maintain the same identity or meaning throughout the knowledge base or in all contexts in which it appears.

Statements may be logical formulae in the logical system, assertions, or propositions. A statement may be described as “evidence.” A statement may be formatted, for example, using logical conventions such as, for the statement “there exists an x such that, if x is tall, Bob is tall,” the format:

∃x|tall(x)→tall(Bob)

Alternatively, statements may be formatted using programming conventions. For example, the statement “for all y, y is an adult if and only if y is greater than or equal to 18 years of age” may be formatted as a function, such as:

```
Function isAdult( students ):
  for each y in students:
    if y.age >= 18:
      y.isAdult = true;
    else:
      y.isAdult = false;
```

Alternatively, statements may be formatted in any simple or complex format that effectively represents their meaning, including a string of characters, a database entry, an object in a programming language, or a piece of structured data.

A knowledge base of statements and probability distributions may be formed as a credal network or logical credal network. Alternatively, multiple knowledge bases may be combined to form one credal network or logical credal network.

In at least one embodiment, one or more experts may identify statements, probability distributions, or both. An expert may be any human who has useful input about statements or probability distributions. For example, four credit card fraud agents working for a credit card company may find that a statement signifying that transaction X is fraudulent is 13%, 14%, 17%, and 19% likely to be true. Alternatively, four agents may each find a range, suggesting that the likelihood of fraud is somewhere between 5-19%, 0-14%, 15-29%, or 18-20%, respectively.

Experts may all be weighed equally. Alternatively, experts may be rated according to a measure of trust, confidence, expertise, significance, or historical success, or any similar measure, and weighted according to such ratings. Experts may have predetermined ratings. Alternatively, expert ratings may be found using an algorithmic process, including a process of artificial intelligence, a process of computational logic, or by probabilistic inferences made at 206.

In another embodiment, statements or probability distributions may be identified from natural language sources of information. Natural language sources may include writing or speech. For example, statements regarding a patient's symptoms may be derived from a text-based submission by the patient describing the patient's symptoms in plain language and submitted through an opt-in procedure. If the patient opts-in, a speech-to-text algorithm may also process speech spoken by the patient to a doctor.

In yet another embodiment, statements may be identified using a process of artificial intelligence. Artificial intelligence may include use of machine learning or a neural network. Artificial intelligence may be used, for example, to recognize statistical or semantic features of statements, predicates, and variables. More specifically, artificial intelligence might recognize that a “coin flip” is accurately represented as a probability of 50%, or that, in the context of a tabletop RPG, “2d20” may refer to the sum of two random numbers each selected in the range 1-20. If the probability distribution of a formula represented as “Tall(Bob)” has a lower bound of 20% and an upper bound of 60%, the probability distribution of the conjunction of “Tall(Bob)” and “Heads(flip)” (where “flip” represents one particular coin flip) may have a lower bound of 10% and an upper bound of 30%. Alternatively, an artificial intelligence algorithm may determine that the probability distribution of “Heads(flip)” and “Tails(flip)” has an upper and lower bound of zero, rather than merely multiplying the odds of events whose outcomes meaningfully depend on one another. Upper and lower bounds may be described, for example, as follows:

0.20≤P(tall(Bob))≤0.60

Alternatively, an artificial intelligence algorithm may process the rules of a game and present state of the game to identify meaningful statements about the state of a game. For example, if a space is marked “1” in a minesweeper-type game, there are nine adjacent spaces, seven of those spaces are revealed and empty, two are hidden, and there is no other information available about those two spaces, an artificial intelligence algorithm may determine that the probability distribution of a mine being present in either of the hidden spaces has a lower and upper bound of 50%. Another set of spaces may offer more complex information, with some visible numbers indicating a higher degree of risk than others; an artificial intelligence algorithm may take this information, along with information about the number of mines and hidden spaces remaining in the puzzle, and may determine probability distributions with: a given space may, for example, have a likelihood of having a mine with a lower bound of 33%, and an upper bound of 52%, one representing a number “2” next to six hidden spaces including the given space, and the other representing a number “3” next to six hidden spaces including the given space alongside other contextual information about the puzzle. In such a case, the lower and upper bounds represent meaningful points about probability of an uncertain nature in light of different pieces of incomplete information, and artificial intelligence may be able to understand meaning in these statistics and determine the correct meaningful upper and lower bounds given the context of the puzzle.

In another embodiment, identifying may be performed using other algorithmic methods. For example, identifying may be performed using a process of computational logic, including inferences made at 206. As another example, given a finite domain of known predicates and constants, identifying may include generating statements at random. Identifying may also include generating probability distributions at random and using a process of human feedback or artificial intelligence to assess the accuracy of randomly generated probability distributions. Alternatively, given a finite domain of known predicates and constants, identifying may include exhaustively listing all valid combinations of predicates and constants.

Identifying may further include accepting statements and distributions from a preexisting source, such as another knowledge base.

In each of the above embodiments, statements and probability distributions may be reviewed by humans such as users or experts in a process of human feedback. Humans may be able to rate, confirm, modify, or reject statements or probability distributions. Low-rated statements and distributions may not be added to, or may be removed from, the knowledge base. Alternatively, low-rated statements and distributions may be tagged with a low confidence rating, or may return to original sources such as experts or artificial intelligence algorithms for alternative distributions.

Identifying may further be performed using a combination of any of the above techniques. For example, artificial intelligence may be used in the context of a natural language understanding algorithm, or in combination with a computational logic algorithm. The knowledge base may include statements identified by different methods. For example, the knowledge base may include statements and probability distributions identified by experts, and other statements and probability distributions identified by processing natural language. Furthermore, some sources may be used for only identifying statements or only for identifying probabilities. For example, a process of natural language understanding may be used to identify statements, while experts determine meaningful probability distributions for each statement.

In an alternate embodiment, there may be more than one knowledge base. For example, in the context of a card game, a knowledge base may be formed for each player, tracking odds in the context of what each player knows, and additionally a knowledge base using all available knowledge, tracking odds in the context of what a game system or an audience knows.

In at least one embodiment, a probability distribution may be described as an upper bound and a lower bound of probability that a statement is true. For example, if five experts predict likelihoods of 30%, 40%, 45%, 47%, and 70% that a team will win a soccer game against another team, the lower bound may be 30% and the upper bound may be 70%. Alternatively, if the probabilistic inference program 150 determines that the prediction of 70% is an outlier, the upper bound may be 47%. An upper bound and lower bound may be equal. For example, the lower bound of probability that a flipped coin will land with the heads side facing up may be 50%, and the upper bound of the same event may also be 50%.

Alternatively, a probability distribution may be described as a central probability and a standard deviation. For example, a probability distribution may be described as 60% with a standard distribution of 10%. As another alternative, a probability distribution may be described by a bar graph or another method of describing a distribution of probabilities, for example where 30%, 40%, 50%, 60%, and 70% likelihoods that Team A will win the soccer game are, respectively, 14%, 20%, 38%, 9%, and 19% likely to be accurate, or favored by that portion of experts.

In at least one embodiment, a knowledge base may include multiple connected statements. For example, a knowledge base may include the statements:

0.5≤P((Friends(x,y)∧Friends(x,z))|Friends(y,z))≤1

0≤P(Friends(x,y)→EnjoysSushi(x)⊕Enjoys Sushi(y))≤0.2

0.4≤P(EnjoysSushi(x)→LivesNearWater(x))≤0.8

0.2≤P(EnjoysSushi(x)→LivesNearWater(x))≤0.3

1≤P(Friends(Alice,Bob))≤1

0.6≤P(Friends(Alice,Charlie))≤0.7

A knowledge base may utilize a limited domain of specific predicates and variables, or other domain-specific rules or features. The domain of the above example may include the predicates “Friends,” “EnjoysSushi,” and “LivesNearWater,” and the constants “Alice,” “Bob,” and “Charlie.” The domain may further include a rule that the “friends” predicate is symmetrical. Symmetry may be represented by an additional statement:

1≤P(Friends(x,y)↔Friends(y,x))≤1

In at least one embodiment, statements may include additional information, including a level of confidence in a probability distribution, the source of the statement, the source of the probability distribution, or a time at which the distribution was identified or most recently updated. A source may, for example, identify a particular artificial intelligence algorithm, or include provenance data relating to an artificial intelligence algorithm for which provenance data is available.

Then, at 204, the probabilistic inference program 150 identifies one or more queries. A query may be identified by a user or by an algorithmic process, such as process of artificial intelligence, a process of computational logic, randomly, or exhaustively given a domain. A query may be a logical formula without a probability distribution. A query may include one or more premises, givens, assumptions, pieces of evidence, or constants particular to that query.

A query may be a logical formula, statement, or question without a probability distribution, with an incomplete probability distribution, or for which a new probability distribution is desired. For example, a query may be the statement, that Bob and Charlie are friends, without a probability distribution, or a question asking the likelihood that Bob and Charlie are friends. Alternatively, a query may ask the upper bound on the likelihood that Bob and Charlie are friends given that the lower bound of the probability is 50%. As another alternative, a query may ask for a narrower probability distribution for a statement with a previously presumed lower bound of 18% and an upper bound of 96%.

In at least one embodiment, a query may include one or more premises. A premise may be a statement that is given as true, a statement that is assumed to be true, or a piece of evidence. For example, a query may ask the likelihood that Charlie lives near the ocean given the premise that Bob and Charlie are friends and further given the premise that Alice likes sushi. A premise may be true only within the scope of the query, or may be true generally and added to the scope of the entire knowledge base.

In an embodiment, a query may be identified by a user. For example, a user who wishes to know the optimal next move in Wordle™ may submit queries asking the likelihoods that the first character in the solution is the letter G, N, or Q, respectively if the second character is the letter U. These queries may be represented as:

P(CharacterOne(G)|CharacterTwo(U))

P(CharacterOne(N)|CharacterTwo(U))

P(CharacterOne(Q)|CharacterTwo(U))

Alternatively, a doctor may submit a query asking the likelihood that a particular patient is suffering from the flu.

In another embodiment, a query may be identified by an algorithmic process, such as a process of artificial intelligence, computational logic, random generation, exhaustive generation, or any other algorithmic method.

A process of artificial intelligence may include the use of machine learning, neural networks, or other similar techniques. For example, an artificial intelligence algorithm may review the knowledge base and predict which queries may be meaningful to users, or are likely to provide results with a high degree of certainty. As another example, a neural network may determine queries to ask in an optimal order to efficiently determine an optimal next move in a game of chess. Alternatively, a neural network diagnostic tool may propose diagnoses and submit queries to the probabilistic inference program 150 to gauge accuracy of the diagnoses.

A process of computational logic may include the use of another computational logic program to determine statements that are likely true according to a simple, single-number probability. The probabilistic inference program 150 may identify queries that ask for probability distributions for statements with simple probabilities above 80%.

In another embodiment, identifying may include generation of random queries within a finite domain, or an exhaustive list of all valid queries given a valid domain. For example, if a domain consists of the predicates “Friends,” “EnjoysSushi,” and “LivesNearWater,” and the constants “Alice,” “Bob,” and “Charlie,” an exhaustive list of queries may ask for probabilities of all statements with no variables, connectors, or quantifiers:

Friends(Alice,Bob)

Friends(Alice,Charlie)

Friends(Alice,Charlie)

EnjoysSushi(Alice)

EnjoysSushi(Bob)

EnjoysSushi(Charlie)

LivesNearWater(Alice)

LivesNearWater(Bob)

LivesNearWater(Charlie)

Alternatively, an exhaustive list of queries may include queries with variables such as:

Friends(Alice,X)

queries with a given number of connectors, such as, as with queries with one connector:

Friends(Alice,Bob)∧Friends(Alice,Charlie)

and queries with a given number of quantifiers, or a given number of connectors and a given number of quantifiers. A query with 2 quantifiers and 0 connectors may be:

∃x:∀y,Friends(x,y)

Alternatively, probabilistic inference program 150 may generate all queries with constants that fit a pattern of statements in a knowledge base with variables. For example, if a knowledge base includes the statement:

Friends(x,y)∧Friends(y,z)

An exhaustive list of queries may include all queries that instantiate variables x, y, and z with constants in the domain.

A randomly-generated set of queries may be one or more queries selected from any of the above exhaustive sets by any random, pseudo-random, or arbitrary procedure. Randomly-generated sets may be generated by generating exhaustive sets and narrowing them to a random set, or by generating sets randomly, for example, by selecting random predicates, constants, variable, connectors, and quantifiers.

Another algorithmic method may include, for example, a game algorithm. As a more specific example, a poker hand rating algorithm may identify hands for each of several players, and submit queries asking for probability distributions corresponding to the chance that each hand wins the current pot given the information available to that player, and an overall probability distribution that each hand wins the current pot given all information available to any player.

Alternatively, queries may be identified from another preexisting source, such as a different knowledge base. For example, if a different program attempts to measure probabilities using single-digit probabilities instead of probability distributions, statements and queries from a knowledge base for that program may be provided to the probabilistic inference program 150 for probabilistic inference using a distribution of probabilities.

A query may be identified by a combination of the above methods. For example, a query may be generated using a process of artificial intelligence and computational logic. Alternatively, queries may be generated exhaustively, and a user may select a narrower set of queries to submit to the probabilistic inference program 150.

Queries may include other information, including a requester, a level of urgency or priority, a desired level of certainty, a time at which a query was identified or updated, or a designation that the response to the query may be confidential.

Next, at 206, the probabilistic inference program 150 finds probabilistic inferences based on one or more queries and the information in the knowledge base. Probabilistic inferences may be statements and probability distributions inferred from the available data using a process of computational logic.

In at least one embodiment, probabilistic inferences are inferred using a process of computational logic. A process of computational logic may include use of axioms, logical induction using classical logical arguments such as modus ponens, modus tollens, biconditional introduction, or hypothetical syllogism, or use of more complex mathematical theories such as the pigeonhole principle. Computational logic may further include the use of mathematical methods, including multiplication, comparison (where the lesser or greater of two probabilities might be taken), knowledge graphs such as the graph depicted in FIG. 3, or counting methods such as combinatorics. Furthermore, computational logic may include use of logical heuristics such as the representativeness heuristic.

Multiplication may include, for example, simple multiplication of two lower bounds. For example, the lower bound of the probability that Alice is tall and Bob is tall may be the lower bound of the probability that Bob is tall times the lower bound of the probability that Bob is tall.

Combinatorics may include use of combinations or permutations. For example, given a domain of nine constants and the knowledge base:

1/504≤P(ThreeTallest(x)∧ThreeTallest(y)∧ThreeTallest(z))≤1/504

0≤P(ThreeTallest(Alice))≤1

combinations may indicate that the upper bound of the probability that Bob and Charlie are in the three tallest of the nine constants is 6/56, representing the cases where Alice is not one of the three tallest members in the group, whereas the lower bound on the probability that Bob and Charlie are in the three tallest members in the group may be 1/56, representing the cases where Alice is one of the top three tallest members of the group.

Alternatively, probabilistic inferences may be inferred according to the rules of a game. For example, in a tabletop RPG, probabilistic inferences may be inferred according to a character's attributes, a difficulty rating for a task, and a selection of dice to be rolled. More specifically, if a task involves taking the sum of the result of rolling two twenty-sided dice, a character's attributes add five points to the sum of the results on the dice, and that score must be greater than or equal to 24 to successfully complete the task, the probabilistic inference program 150 may determine lower and upper bounds of 61.75% that the player will successfully complete the task.

In another embodiment, drawing probabilistic inferences may include use of probability models and simulations. For example, a model of a chess game may be used in conjunction with a knowledge base about the chess game to determine a distribution of probabilities that a given move will result in a win. The probabilistic inference program 150 may then simulate ten rounds of one million chess games each using the model of the game. The probabilistic inference program 150 may finally determine that the lower bound of the probability of victory is equal to the lowest likelihood of victory in the ten rounds of simulation, and the higher bound is equal to the highest likelihood of victory.

In yet another embodiment, drawing probabilistic inferences may include use of artificial intelligence, including use of machine learning, federated learning, or a neural network. For example, a neural network may be trained using historical medical data obtained using opt-in procedures and historical instances of probabilistic inference from imprecise knowledge, and may then be used to determine probability distributions in response to queries.

In a further embodiment, probabilistic inferences may be drawn using any other relevant optimization algorithm, including graph traversal algorithms or nonlinear constraint programming.

Probabilistic inferences may be drawn using a combination of the above methods. For example, combinatorics may be used to simplify probability calculations to be used in probability models and simulations.

In at least one embodiment, probabilistic inferences may be added to the knowledge base, or to a separate knowledge base of probabilistic inferences. Either knowledge base may then be used for other purposes, such as additional probabilistic inferences, data for machine learning, or any other purpose.

Probabilistic inferences about a game may describe probability distributions that different moves in a game will win eventually, win immediately, or win within a certain number of moves. For example, in a game of Mastermind®, where queries are an exhaustive list of questions asking the probability that each valid move will be the correct solution, the probability that each valid move will lead to a win according to the game rules, and the probability that each valid move will lead to a win by move number 4, move number 5, and move number 6, an optimization algorithm may use probabilistic inferences about the queries to recommend an optimal next move to a user.

The probabilistic inference program 150 may determine an order in which to make or propagate inferences. inferences may be made in an order according to properties of the information used to make the inference, such as: a confidence rating of the information; certainty about the probability of the statements, where narrower ranges may be given higher priority (for example, a statement with a lower bound of 40% and an upper bound of 60% may be favored over a statement with a lower bound of 30% and an upper bound of 70%); a degree of certainty about a statement (where, for example, statements with upper bounds close to 0 or statements with lower bounds close to 1 are considered more certain to be true or false); a recency with which information was found (where newer or older information may be preferred); or a level of redundancy of information available for inference. Such properties may also be used to determine weights between nodes on a knowledge graph.

Alternatively, inferences may be made in an order according to properties of the information being induced, such as: a measure of the urgency with which that information is needed; a measure of current uncertainty about the probability of the information (where queries and statements without probability distributions, or with lower bounds of 0 and upper bounds of 1, are prioritized over statements with lower bounds of 10% and upper bounds of 90%); the number of premises for the given query, where a query with a greater number of premises is given higher priority; the time at which queries or statements are identified; or a time at which queries or statements were most recently updated. Such properties may also be used to determine weights between nodes on a knowledge graph.

As another alternative, inference may be performed according to a weight between two nodes on a knowledge graph. For example, inferences may be made for the statement with the lowest or highest weight arrow leading to that statement.

Inference may be performed any number of times, including: once for each query; repeatedly and continuously as information is added to the knowledge base, as queries are identified, or as information is modified, such as by inference; until a particular piece of information is found; or until some other condition is met, such as a game ending, or a transaction being verified as legitimate or fraudulent.

In an alternate embodiment, inferences may be used to rate, weigh, rank experts based on trust, confidence, expertise, significance, or historical success, or any similar measure. Inference may be performed based in part on a ranking of experts. For example, statements may be divided and ordered based on the rank of the expert who identified the statements, and inferences may favor statements made by higher-ranked experts.

Referring now to FIG. 3, a knowledge graph marking connections between statements is depicted according to at least one embodiment. This knowledge graph may alternatively be referred to as a primal graph. An arrow between two statements may indicate a causal or logical link. Statements or arrows on the graph may indicate a weight that may be used to determine an order of propagation for inference at 206.

Predicates “Friends,” “ES,” and “LNW” may indicate that two people are friends, that a person enjoys sushi, and that a person lives near water, respectively. Constants A, B, and C, may represent people named Alice, Bob, and Charlie. A relevant knowledge base may, for example, include the statements and probabilities:

0.5≤P((Friends(x,y)∧Friends(x,z))|Friends(y,z))≤1

0≤P(Friends(x,y)→EnjoysSushi(x)⊕Enjoys Sushi(y))≤0.2

0.4≤P(EnjoysSushi(x)→LivesNearWater(x))≤0.8

0.2≤P(EnjoysSushi(x)→LivesNearWater(x))≤0.3

1≤P(Friends(Alice,Bob))≤1

0.6≤P(Friends(Alice,Charlie))≤0.7

Where symbols ∧, |, and ⊕, may indicate conjunction, a condition or implication, and exclusive disjunction; and where x, y, and z are variables local to each statement.

It may be appreciated that FIGS. 2 and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
identifying a knowledge base of one or more statements and first probability distributions corresponding to each of the one or more statements;
identifying one or more queries; and
determining logical inferences about and second probability distributions for queries from the one or more queries or statements from the one or more statements based on information in the knowledge base.

2. The method of claim 1, wherein the first probability distributions and second probability distributions consist of a lower bound of probability and an upper bound of probability that the corresponding statement is true.

3. The method of claim 1, wherein logical inferences and second probability distributions correspond to queries from the one or more queries.

4. The method of claim 1, wherein identifying the knowledge base includes identifying determined logical inferences and second probability distributions.

5. The method of claim 1, wherein at least one query from the one or more queries includes one or more premises that are assumed true in a context of the query.

6. The method of claim 1, wherein identifying a knowledge base is performed based on a natural language description of information.

7. The method of claim 1, wherein identifying a knowledge base is performed using artificial intelligence and a neural network.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying a knowledge base of one or more statements and first probability distributions corresponding to each of the one or more statements;
identifying one or more queries;
determining logical inferences about and second probability distributions for queries from the one or more queries or statements from the one or more statements based on information in the knowledge base.

9. The computer system of claim 8, wherein the first probability distributions and second probability distributions consist of a lower bound of probability and an upper bound of probability that the corresponding statement is true.

10. The computer system of claim 8, wherein logical inferences and second probability distributions correspond to queries from the one or more queries.

11. The computer system of claim 8, wherein identifying the knowledge base includes identifying determined logical inferences and second probability distributions.

12. The computer system of claim 8, wherein at least one query from the one or more queries includes one or more premises that are assumed true in the context of the query.

13. The computer system of claim 8, wherein identifying a knowledge base is performed based on a natural language description of information.

14. The computer system of claim 8, wherein identifying a knowledge base is performed using artificial intelligence and a neural network.

15. A computer program product, the computer program product comprising:
one or more computer-readable tangible storage medium and program instructions stored on at least one of the one or more tangible storage medium, the program instructions executable by a processor capable of performing a method, the method comprising:
identifying a knowledge base of one or more statements and first probability distributions corresponding to each of the one or more statements;
identifying one or more queries;
determining logical inferences about and second probability distributions for queries from the one or more queries or statements from the one or more statements based on information in the knowledge base.

16. The computer program product of claim 15, wherein the first probability distributions and second probability distributions consist of a lower bound of probability and an upper bound of probability that the corresponding statement is true.

17. The computer program product of claim 15, wherein logical inferences and second probability distributions correspond to queries from the one or more queries.

18. The computer program product of claim 15, wherein identifying the knowledge base includes identifying determined logical inferences and second probability distributions.

19. The computer program product of claim 15, wherein at least one query from the one or more queries includes one or more premises that are assumed true in the context of the query.

20. The computer program product of claim 15, wherein identifying a knowledge base is performed based on a natural language description of information.
